(19) United States
(12) Patent Application Publication
(10) Pub. No.: US 2014/0159883 A1
(43) Pub. Date: Jun. 12, 2014

(54) INTRUSION AND THEFT ALERT DEVICE REMOTELY ARMED AND DISARMED BY MOBILE PLATFORM APPLICATION

(71) Applicant: RICHARD DAMIANI, MALVERNE, NY (US)

(72) Inventor: RICHARD DAMIANI, MALVERNE, NY (US)

(21) Appl. No.: 13/947,174

(22) Filed: Jul. 22, 2013

Related U.S. Application Data
(60) Provisional application No. 61/675,777, filed on Jul. 25, 2012.

(51) Int. Cl. B60R 25/102

(52) U.S. Cl. CPC B60R 25/102
USPC 340/426.13; 340/426.18

(57) ABSTRACT

The present disclosure is directed to an intrusion tracking and management system. The system includes portable intrusion alert devices that communicate with remote user devices over a central server. The central server and remote user devices track, collect, and manage position location indicia type transmissions from the intrusion alert devices. These transmissions are automatically broadcast to the central server from an intrusion alert device once armed (“armed mode”). The arming and disarming of an intrusion alert device occurs remotely from the intrusion alert device itself making it difficult, if not impossible, to disable its broadcasting position location indicia without destroying it.

### CROSS-REFERENCE TO RELATED APPLICATIONS

This application claims the benefit of U.S. Provisional Application No. 61/675,777 filed on Jul. 25, 2012, commonly owned and assigned to the same assignee hereof.

### BACKGROUND

1. Technical Field

The present disclosure is directed to wireless anti-theft systems, and in particular to systems in which an anti-theft device sends remote alerts to a platform in the event of intrusion and/or theft.

2. Background Information

People leave their cars unattended most of the day and night, and usually do not know if anything has happened to their vehicle until hours later. They cannot react quickly if they cannot hear the car alarm that is sounding outside. This leads to many vehicle thefts and a lower rate of recovery.

Most car alarms simply make noise and scare off the intruder. However, if the thief disables the alarm, the owner will not know anything has happened until he/she returns to the vehicle, which may be hours later.

Moreover, conventional car alarm systems are either built-in systems, integrated by a manufacturer, or of the after-market kind that operate in a same or similar fashion. Such devices can be expensive to purchase and/or complicated to install.

There is a need for a vehicle anti-theft device that sends remote alerts in the event of intrusion and/or theft.

There is also a need for a vehicle anti-theft device that is low cost (less than $200), easy to install or use, portable, and configured to be interoperable with mobile and web-based platforms.

Furthermore, there is a need for such vehicle anti-theft device to be sufficiently stealth and or tamper proof to prevent its being easily found and/or easily disarmed.

### BRIEF DESCRIPTION OF THE DRAWINGS

FIGS. 1A and 1B show a vehicle intrusion alert device (VIAD) for sending an alert upon a vehicle disturbance according to an exemplary embodiment, where FIG. 1A is a top view of the VIAD covered and illustrating a solar power panel as one form of the rechargeable battery source for powering the VIAD, and FIG. 1B is a top view of the VIAD uncovered and showing internal components.

FIG. 2 is a schematic representation showing usage of a vehicle intrusion tracking and management system according to an exemplary embodiment.

FIG. 3 is a hardware block diagram of the VIAD of FIG. 1.

FIGS. 4 to 11 are different graphical user displays for loading and setting up of a mobile platform application (MPA) in accordance with an exemplary embodiment.

### SUMMARY

The present disclosure is directed to an intrusion tracking and management system. The system includes portable vehicle intrusion alert devices (VIADs) that communicate with remote user devices over a central server. The central server and remote user devices track, collect, and manage position location indicia type transmissions from the VIADs. These transmissions are automatically broadcast to the central server from a VIAD once armed (“armed mode”). The arming and disarming of a VIAD occurs remotely from the VIAD itself, making it difficult, if not impossible, to disable its broadcasting position location indicia without destroying it.

In one exemplary embodiment, a VIAD is further configured to generate an intrusion alert generated by an integrally designed impact sensor. Remote user devices, such as smart phones, tablets and the like smart mobile devices, include a mobile platform application—running for example on Android or iOS—configured to be able to communicate remotely with registered VIADs.

By moving all of the intelligence, tracking, management, display, and many more features of a conventional anti-theft device into a remote device, the VIAD can be manufactured with minimum components, and made sufficiently small so that it can be inconspicuously hidden in a vehicle compartment, under the seat, or disguised within an accessory such as a cup-holder or the like.

Also, a VIAD can be made without electronic buttons, displays, or LEDs which might let an intruder to come to learn of its existence or purpose if found. In one scenario, the VIAD is equipped with a rechargeable battery source, such as a solar power panel.

### DETAILED DESCRIPTION

The word “exemplary” is used herein to mean “serving as an example, instance, or illustration.” Any embodiment described herein as “exemplary” is not necessarily to be construed as preferred or advantageous over other embodiments. It is to be understood that the terminology used herein is for purposes of describing particular embodiments only, and is not intended to be limiting. The defined terms are in addition to the technical and scientific meanings of the defined terms as commonly understood and accepted in the technical field of the present teachings.

As used in the specification and appended claims, the terms “a”, “an” and “the” include both singular and plural referents, unless the context clearly dictates otherwise. Thus, for example, “an apparatus” or “a device” includes one apparatus or device as well as plural apparatuses or devices.

In addition, the terms “user”, “vehicle owner”, “owner”, “cell phone user”, “cell phone owner”, “customer”, “registered owner”, and the like terms are all intended to refer to the individual or set of individuals with authority to receive alerts on their remote user devices, which remote user devices are defined and described below.

The present disclosure is directed to an intrusion tracking and management system. The system includes portable vehicle intrusion alert devices (VIADs) that, in accordance with an exemplary embodiment, communicate with remote user devices over a central server. The central server and remote user devices track, collect, and manage position location indicia type transmissions from the VIADs. These transmissions are automatically broadcast to the central server from a VIAD when such are armed (“armed mode”).

The arming and disarming of a VIAD occurs remotely from the VIAD itself making it difficult, if not impossible, to disable its broadcasting position location indicia, at least not without taking the VIAD apart or removing the battery. In one scenario, removing the battery triggers an instant alert to the user/vehicle owner.

In one scenario, a rechargeable battery source powered by solar power is provided and integrally designed within the package.

Remote user devices are intelligent programmable devices, usually configurable to download and run a variety of mobile platform applications, but may also include less intelligent devices, such as GSM only devices capable of completing calls and sending and receiving text/SMS messages. Intelligent devices include devices such as smart phones, tablets and the like smart mobile devices. Mobile platform applications are applications capable of executing on Android and/or iOS mobile platforms, Symbian, Windows Mobile, and other like platforms.

In accordance with an exemplary embodiment, the VIAD is a transponder that generates an intrusion alert triggered by a built-in sensor (e.g., an infrared sensor, accelerometer, pressure sensor, or the like) in response to detected motions of the type likely to be made by a possible intruder. The alert is transmitted over the wireless network to inform the owner or a service with which the owner is registered of a possible intrusion.

By moving all the intelligence, tracking, management, display, and many more features of a conventional anti-theft device into a central server and smart type remote user devices, the VIAD can be manufactured with minimum components. Fewer components translate into smaller form factor and lower cost. Smaller size, in turn, permits safekeeping inside a cabin of a vehicle, inconspicuously out of plain view, under the seat, or disguised within an accessory such as a cup-holder or the like.

Also, the VIAD may be made without electronic buttons, displays, switches, or LEDs. This not only reduces cost but further makes it hard to find when hidden. If found, the lack of switches prevents tampering and disabling/disarming of any kind.

As explained, VIADs are configured to be communicably coupled to the central server. The central server collects and feeds position location indicia and intrusion alerts to and from the VIADs and to corresponding authenticated remote user devices.

In one scenario, authenticated remote user devices include an appropriate mobile platform application (MPA) with graphical user interfaces that allow VIAD owners to uniquely and selectively set the operating mode of an associated VIAD between armed and disarmed modes.

The small form factor and minimum number of necessary components from which to generate position location indicia and intrusion alerts also plays a role in costs of manufacture, scalability of future designs, customization on a customer by customer basis, and the like. Fewer components also means lower power consumption which translates into very long battery life between charges. Also, once charged, recharging can be performed rather quickly.

In a further scenario, being in armed mode is akin to being in “stealth” mode. The intent however is not to disguise a VIAD and its operating blocks within another electrical device which adds to the cost, size and/or power consumption of the disguised VIAD, unless such a device is a cup holder, mechanical dispenser of some sort, or other commonly found accessory in a car within which a VIAD may be disguised.

Another deployment use of the VIAD may be to place it on a cradle or affix it to the interior side window in plain view. An intruder who recognizes the device as a tracking and alarm device has no way of knowing whether the VIAD is armed or not. This serves as a deterrent in itself. The use of a charging cradle may satisfy the specific needs of certain segment of the market for such devices who prefer to not have to worry about charging, while still having the flexibility to do so, if they so desire.

Once armed, a VIAD may be programmed to automatically generate position location indicia and to transmit these indicia wirelessly to the central server, and from there to the communicably coupled MPA.

The MPA is preferably a mobile or web-based platform configured to access a database of stored VIAD records over the internet. The database may be a cloud-based storage device for example.

VIAD transmission will typically be time-stamped as well to maintain and track chronologically when certain events may have occurred. VIAD records are available to any corresponding authenticated remote user device via its MPA. The MPA is configured to allow logging-on and retrieval of data from the database via an appropriate management information system deployed at the central server.

When a VIAD detects an intrusion, the intrusion alert is forwarded automatically by an armed VIAD to the central server from where it will get distributed to one or more remote user devices associated with the VIAD. The intrusion alert message can take many forms, and may be sent to multiple devices at once, including devices other than smart mobile devices. In one scenario, intrusion alert messages are sent as GSM text/short messages, by email, or by directly placing an automated call to a predefined party.

The sending of an intrusion alert serves as a notification to the user to take appropriate action. A graphical user interface (GUI) at the MPA allows the user to call up a graphical position location plot that reveals a mapped position trajectory of the VIAD, and by association the vehicle in which the VIAD is hidden (“navigation mode”). This information may be used by the owner to deduce if a particular vehicle appears to be under threat of being taken without authorization. If so, the mapped position trajectory will also show actual position coordinates.

In a further aspect, the wireless network is a cellular network and the message is an alert message that is transmitted over the network to a communicating base station, repeater, or other cellular network equipment. In one scenario, the network equipment is communicably coupled to a service/platform, preferably over the web, which is in turn provided the alert message, along with position or location coordinates of the transmitting device, from the network equipment. The position location may be GPS coordinates transmitted from the device (assuming it is equipped with a GPS type receiver), or determined using known triangulation techniques at the network end, or a combination of both (e.g., E-GPS/A-GPS).

In another scenario, the VIAD position location indicia is forwarded to third parties electronically, by a specially set up service or platform, hosted and supported by the party maintaining the central server, or by another party contracted out to support such activities. For example, such service or platform sends the information from the central server to a police dispatch service, which in turn forwards this information to on-board police cruisers to help field officers identify and track a current position of a VIAD in real time, and hence catch the intruder/thief.

In a further scenario, the MPA GUI generates a selection screen with an option to place a call to report a theft or other event in response to the alert.

In one exemplary embodiment, the switching to navigation mode involves downloading/retrieving historical data and displaying vehicle position location activities for one or more intervals of operation during which the VIAD was in armed mode.

The central server tracks and manages activities and maintains a database of stored, time-stamped records created by information transmitted from/to the VIADs and the remote user devices. In addition, the central server may also perform authentication, registration, and VIAD initialization, as well as assist in the serving of stored time-stamped records of position location indicia and intrusion alert histories to authenticated remote user devices.

In another scenario, the device is configured to generate continuous alert messages over predefined increments from which position information is generated as explained.

In a further aspect, a web-based platform is provided accessible over the web over an appropriate mobile application, such as an iPhone application, an Android application, or similar smart-phone based application, as well as by conventional internet browsers. The platform includes a graphical user interface (GUI). The GUI includes a display portion to preferably graphically map identified positions of the transponder/device, as messages transmitted therefrom to the network are received by the platform, processed and mapped for display.

The transponder is intended to have a small form factor, the size of a smart phone device, or smaller, and in one scenario may be integrated into another device found in a vehicle, such as an I-Pass device.

In one scenario, in the case of an integrated I-pass device, it is contemplated that the vehicle alert functionality is managed and operated by the I-pass service provider. In another scenario, the I-pass functionality is non-existent or non-operable.

The transponder is further intended as a low cost device (less than $200). A sensor sensitivity button or control may be provided.

In another scenario, the device may include a disable function uniquely triggered to disable or prevent the alarm device from transmitting alert messages. Such disable function may include a button capable of detecting a sequence of movements, key strokes, or may include biometric enable/disable functionality. The device may also be disabled through the mobile application so as to not send alerts to a user when he/she is in the vehicle under normal operation.

In a preferred implementation, the sensor is set to respond to any type of intrusion into the vehicle. However, it will not respond to disturbances outside of the vehicle such as movement, noise, wind, etc.

In an exemplary embodiment, each device contains a unique ID (e.g., static IP address). The device includes smart phone applications and drivers for uploading a corresponding smart-phone application (either by USB or wirelessly). In another scenario, the appropriate applications and/or drivers are downloaded from an appropriate URL, web store, or the like. The unique ID is associated with the application and used to register the application to the platform. In turn, alert messages and/or position information are automatically generated via the smartphone residing application in the event of an intrusion.

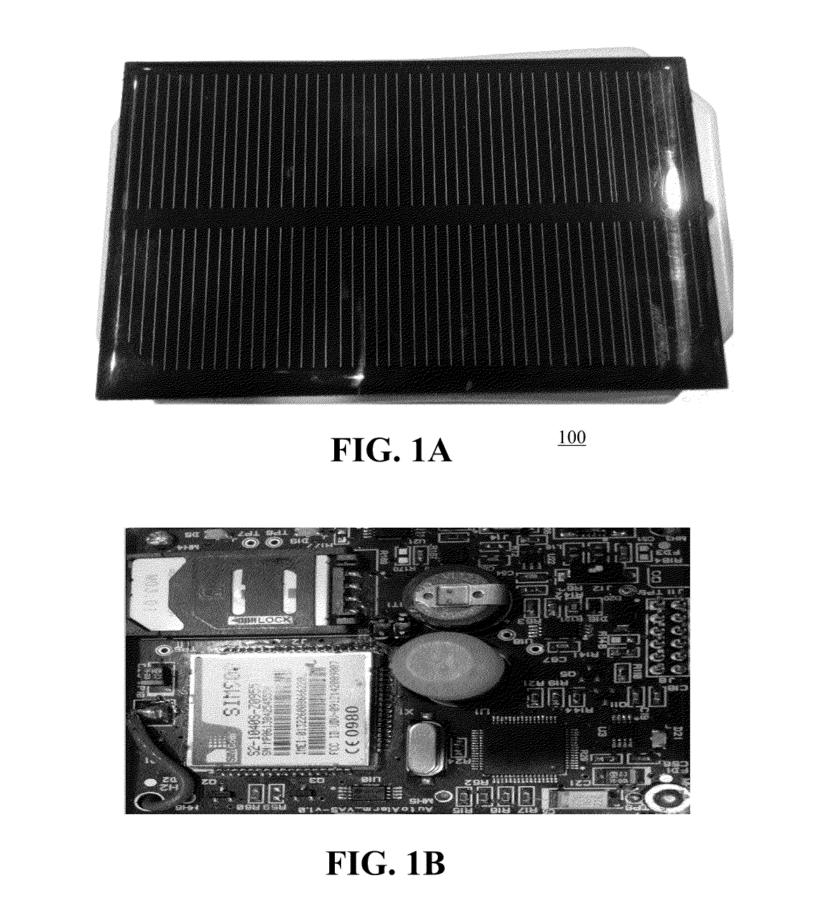

FIGS. 1A and 1B show a vehicle intrusion alert device (VIAD) 100 for sending an alert upon a vehicle disturbance according to an exemplary embodiment. FIG. 1A is a top view of the VIAD covered and illustrating a solar power panel as one form of the rechargeable battery source for powering the VIAD. FIG. 1B is a top view of the VIAD uncovered to show internal components.

The VIAD can be manufactured as a fully assembled and packaged unit that can be simply installed or hidden somewhere in a vehicle. If installed, the VIAD can be easily mounted to the interior of one's car using Velcro® or double sided tape, for example. The VIAD can be set up ahead of time by attaching the device to a computing device with appropriate software installed, or may be set up through the server via, for example, an interne connection. In the case where an MPA is used to arm and disarm the device, the MPA may also be used to program and set up the device.

While the above describes a VIAD for detecting intrusions into vehicles, the VIAD can be used in other applications. For example, the VIAD can be placed inside of other items, such as a suitcase, purse, coat, or the like, and signal movement to a remote user device configured to receive broadcast signals therefrom when the built-in sensor picks up (detects) a disturbance (strong vibration, sound, motion, etc.) associated with the item on or in which the VIAD is placed. The VIAD can also be placed in any type of vehicle or other movable object, on a person, or in a house.

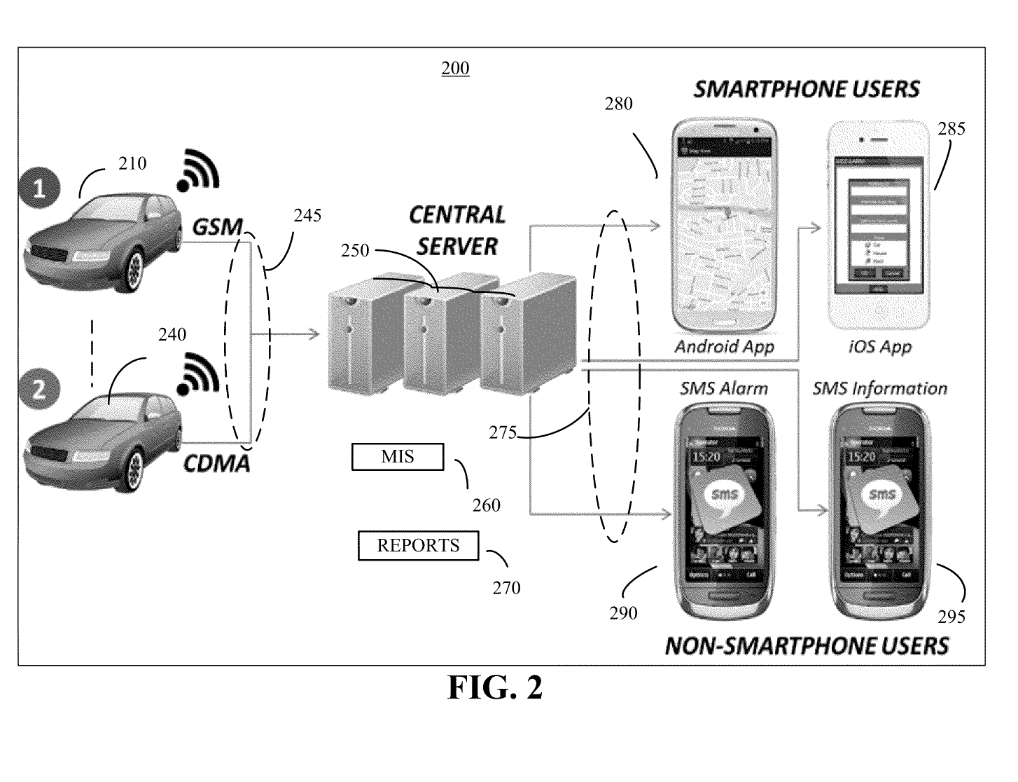

FIG. 2 is a schematic representation showing usage of a vehicle intrusion tracking and management system (VITMS) 200 according to an exemplary embodiment.

VITMS 200, as shown, includes multiple vehicle VIADs 210-240 coupled via assigned first wireless channel links 245 to a central server 250. Central server 250 includes a management information system (MIS) 260 and database of VIAD records (reports) 270. Central server 250 communicates, in turn, over second wireless channel links 275 with smart mobile devices 280, 285 and regular devices 290, 295 (collectively “remote user devices”).

Central server 250 performs all the task management functions necessary to track and manage the exchange of information between VIADs 210-240 and remote user devices 280-295, in the manner explained earlier.

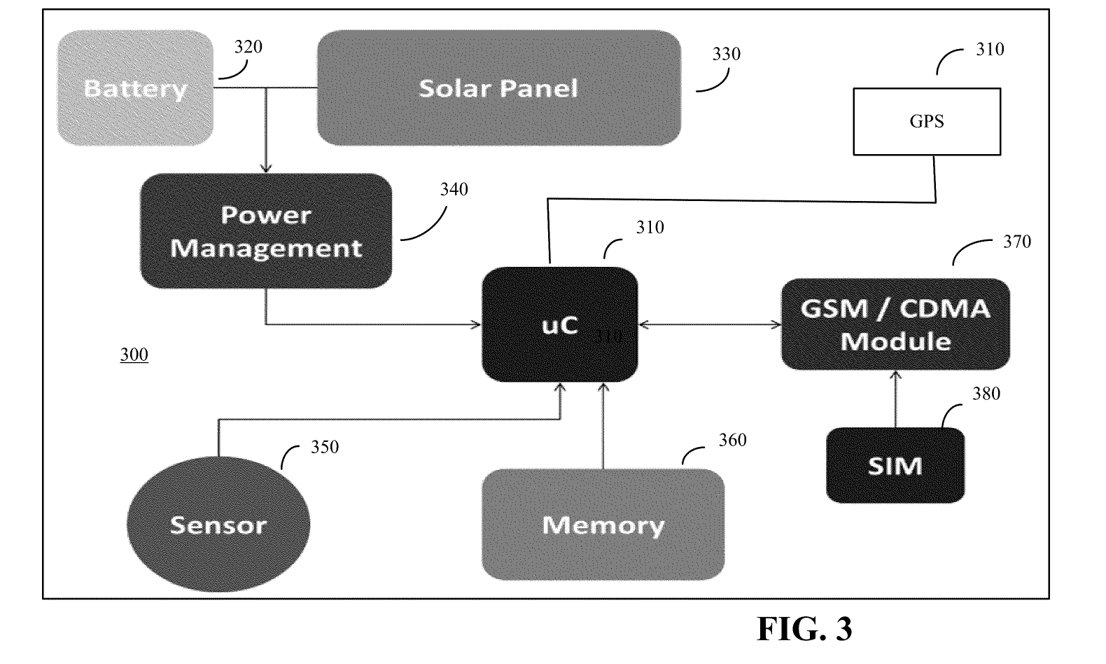

FIG. 3 is a hardware block diagram 300 of the VIAD 100 in FIG. 1 in accordance with an exemplary embodiment.

VIAD 100 is a transponder and, as shown, includes a microcontroller (uC) 310, an optional GPS receiver 315, a rechargeable battery source 320 coupled to a solar panel component 330, a power management circuit 340, a sensor 350, a memory 360, a modem (GSM, 3G, 4G, etc.) 370, which in turn may be coupled to an optional SIM (subscriber identity module) card 380. These components are mounted on a circuit board within an enclosure. In an alternative configuration, the functionality of SIM card 380 is integrally formed with modem 370.

A single printed circuit board is preferably provided which houses all key electrical components, including a baseband processor, impact sensor, and RF components.

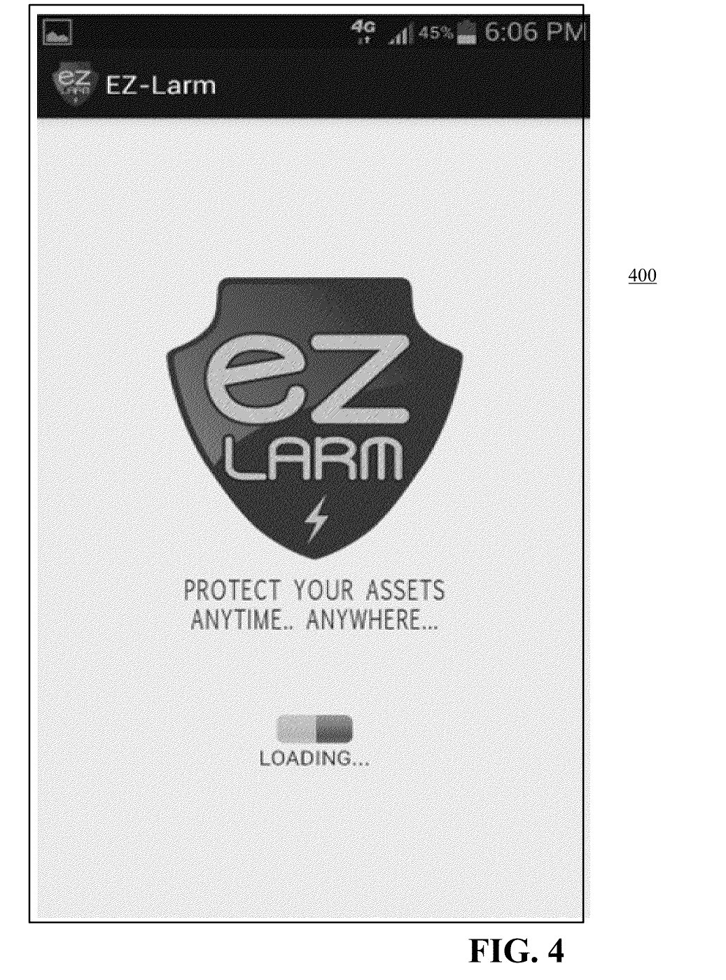

FIGS. 4 to 11 are different graphical user displays for loading and setting up of a mobile platform application (MPA) in accordance with an exemplary embodiment.

Prior to the MPA being functionally set up in a smart mobile device, it may need to be downloaded from a host. The host may be the central server, the modem network provider, or a third party (e.g., Apple or Android Store). Alternatively, the MPA is bundled with the phone at time of purchase.

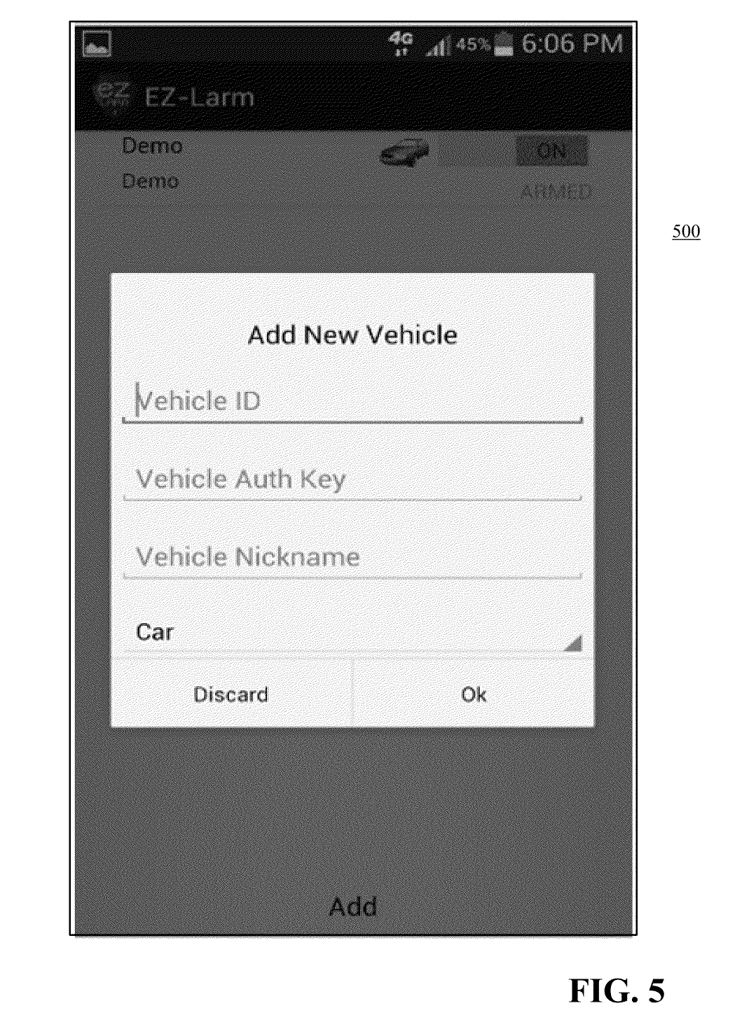

Referring to FIGS. 4 to 7, after the MPA is downloaded, the first step is to load the program so it is executing in the background (screen 400, FIG. 4). Once loaded, the MPA walks the user through a series of steps by which to set up a smart mobile device (for example, either of devices 285, 290) for communication with corresponding ones of VIADs 210-240. In fact, the same MPA allows for tracking of multiple registered VIADs. Screen 500 (FIG. 5) shows the process for link registering and authenticating a smart mobile device to communicate with one or more VIADs. In each instance, the user must know a priori the VEHICLE ID and VEHICLE AUTH KEY, assigned to each VIAD that the user is attempting to connect to.

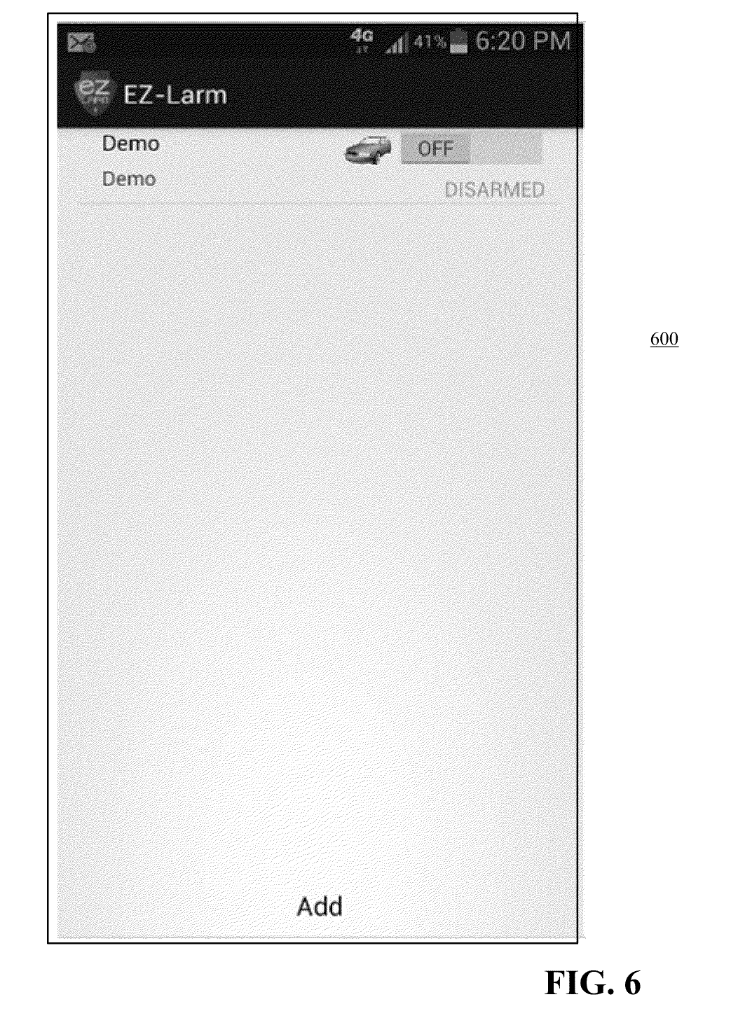

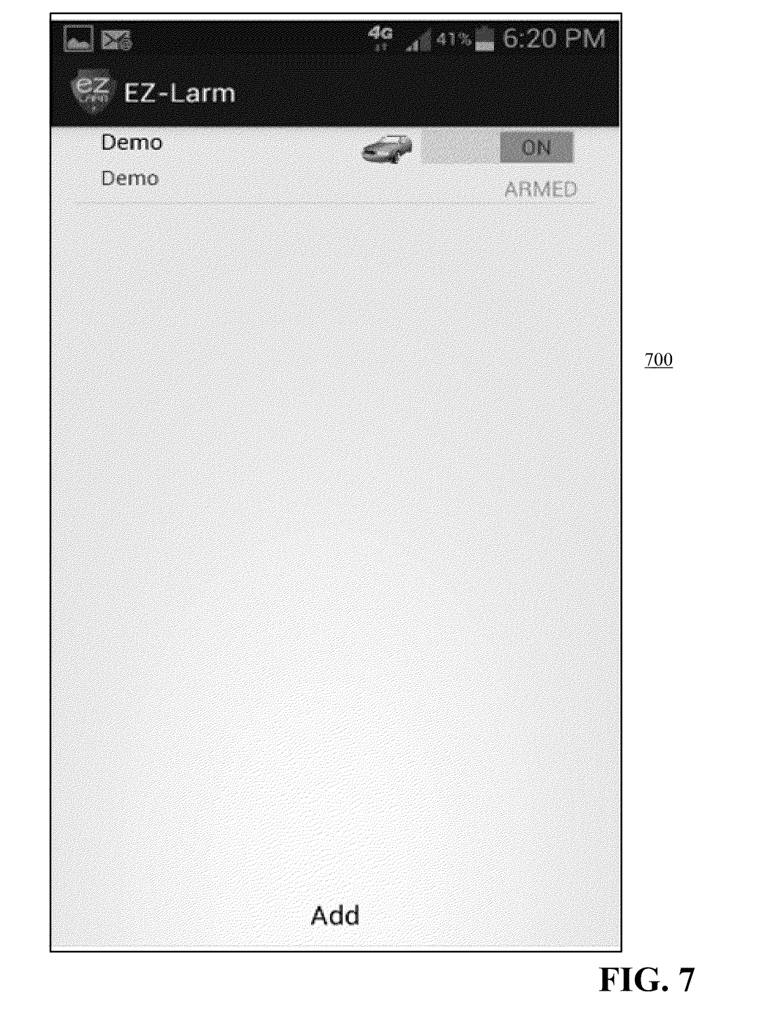

Once connected, the user is presented with a new screen 600 (FIG. 6) which permits the user to set the operational mode of a VIAD once a communication link is established. In the example scenario, a user selection slide bar is provided in the menu of screen 600 which allows the user to enable (“arm”) the VIAD remotely from his cell phone. In screen 700 (FIG. 7), the application interface is refreshed and the VIAD is shown as being armed.

Having activated the one or more VIADs that a user wishes to monitor remotely, it simply leaves the MPA GUI and returns to the normal phone menu. Here, an icon may be generated to remind the user that the MPA is running in the background.

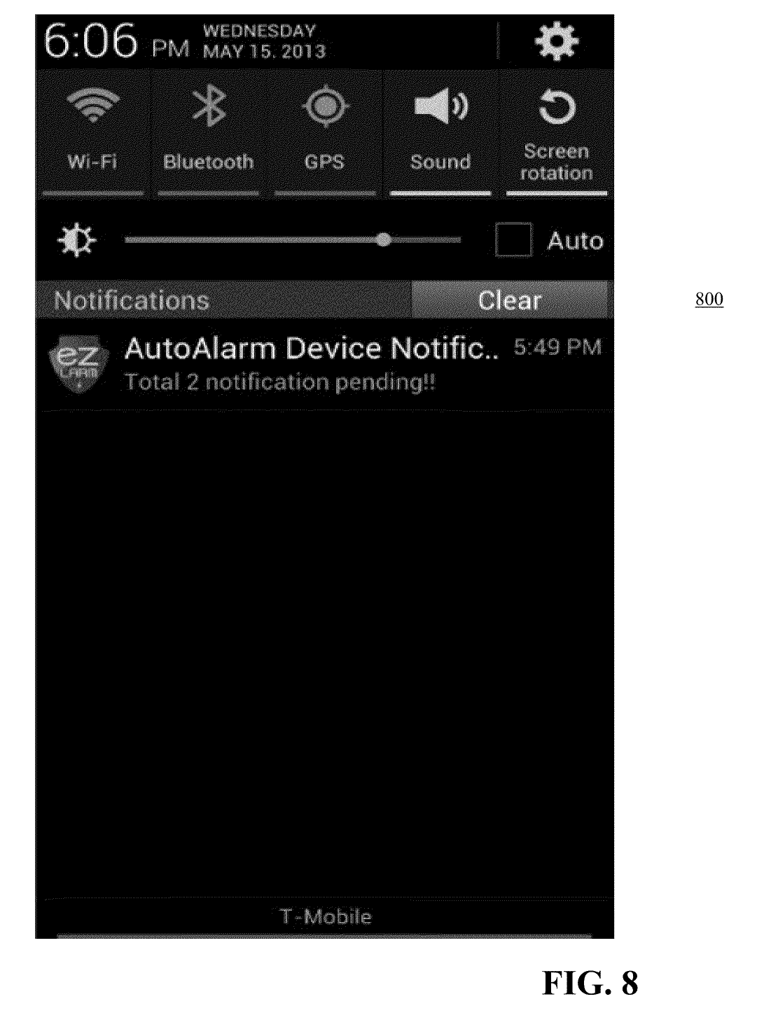

Referring to FIGS. 8 to 11 next, if and when an intrusion is detected, an intrusion alert (loud audible sound for example) is generated by the MPA and an indication similar to that in screen 800 (FIG. 8) is presented.

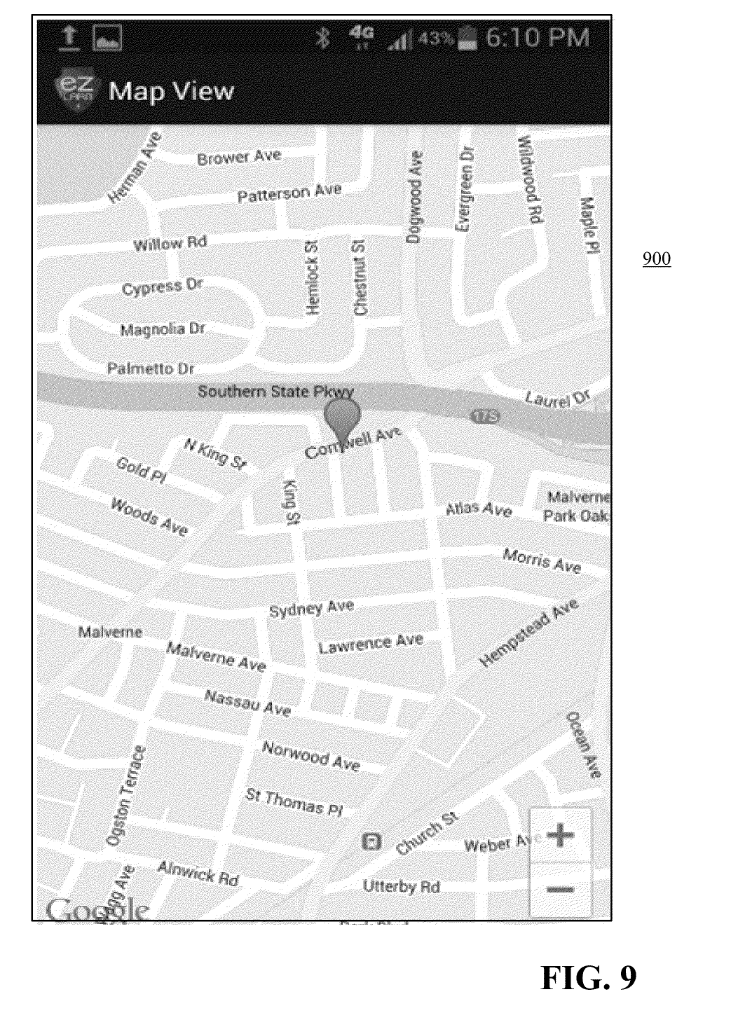

At this point in time, the user will want to switch to navigation mode (screen 900, FIG. 9). Here, a graphical position location plot is automatically generated and presented to the user. By tracking VIAD position this way, in real time, it is possible to detect current vehicle position. In the event the vehicle is continually moving, it is technically possible to physically get in another vehicle and, using one's smart phone, maintain constant position location contact with the intruder and the vehicle.

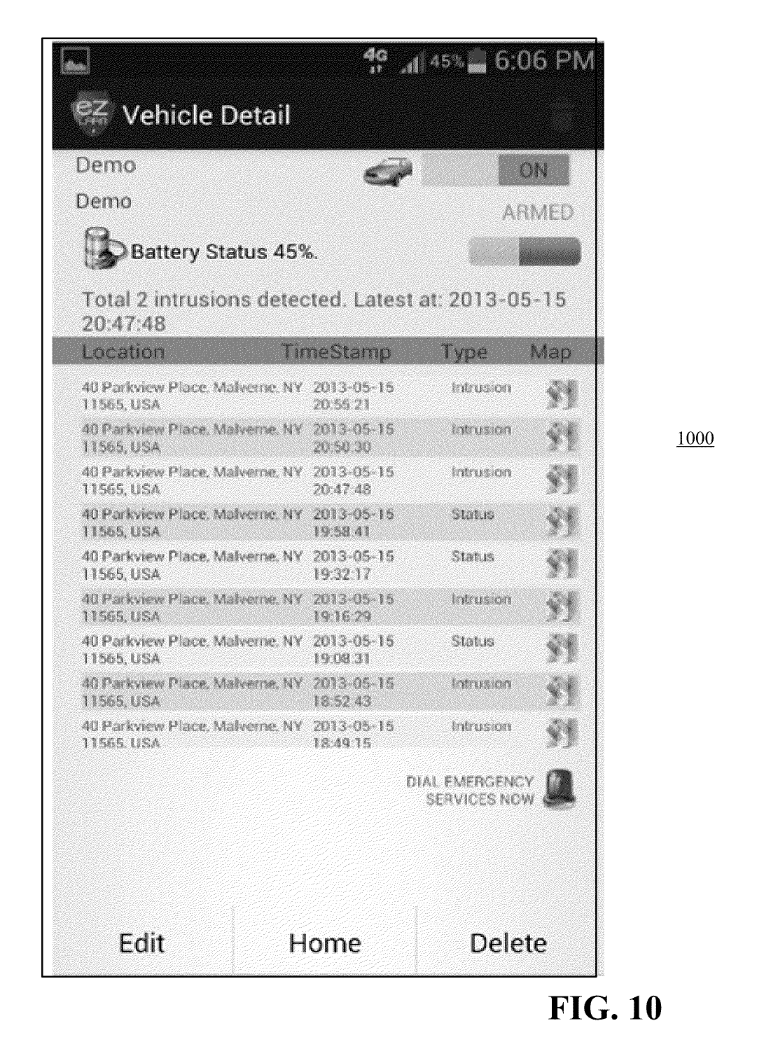

If the signal is lost, the battery of the VIAD goes out, or if one simply wants a track history of vehicle position over a given period, the MPA provides a screen interface 1000 (FIG. 10) which allows being able to call up and reveal details concerning past time intervals. Of course, this is only possible for those intervals during which the VIAD had been armed, either by the current device or another device with access and control of the VIAD.

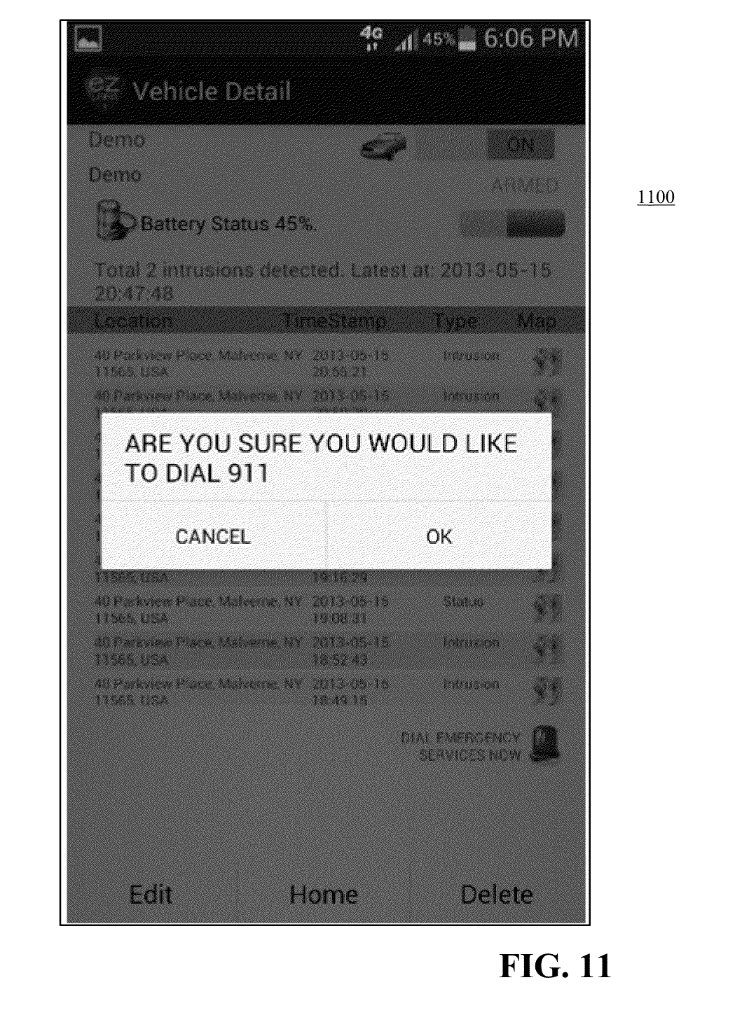

In a real theft or vandalism event, the MPA includes functionality which allows the user easy and quick access to emergency services (screen 1100, FIG. 11).

It should be readily appreciated that the VIAD can include various sensors to determine a disturbance to the vehicle. The sensors can include, for example, infrared sensors, camera-based sensors, glass break sensors, and the like. The sensors are typically attached to the enclosure, but may be installed at a location remote from the enclosure and configured to send a signal, either via an electrical connection or wirelessly.

The battery can be an internal, replaceable or rechargeable battery. In some embodiments, the device can attach to the vehicle's electrical system and obtain power from the vehicle's battery, with the option of internal battery backup. The battery on the device may be recharged through the vehicle's electrical system, through a small solar panel, or the like.

While example embodiments of a communications device configured to facilitate tracking and managing as proposed herein have been described in connection with various computing devices/processors, the underlying concepts can be applied to any computing device, processor, or system capable of facilitate a stealth mode as described herein. The methods and apparatuses described herein, or certain aspects or portions thereof, can take the form of program code (i.e., instructions) embodied in tangible storage media having a physical structure, such as floppy diskettes, CD-ROMs, hard drives, or any other machine-readable storage medium (computer-readable storage medium), wherein, when the program code is loaded into and executed by a machine, such as a computer, the machine becomes an apparatus for controlling a communications device in accordance with motion thereof. A computer-readable storage medium, as described herein is an article of manufacture. In the case of program code execution on programmable computers, the computing device will generally include a processor, a storage medium readable by the processor (including volatile and non-volatile memory and/or storage elements), at least one input device, and at least one output device. The program(s) can be implemented in assembly or machine language, if desired. The language can be a compiled or interpreted language, and combined with hardware implementations.

The methods and apparatuses for tracking and managing a VIAD can also be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes an apparatus for facilitating a stealth mode. When implemented on a general-purpose processor, the program code combines with the processor to provide a unique apparatus that operates to invoke the functionality the stealth mode implementation.

While the arming and disarming, and initializing and setup modes have all been described in connection with the various embodiments of the various figures, it is to be understood that other similar embodiments can be used or modifications and additions can be made to the described embodiments. For example, one skilled in the art will recognize that using a communications device to facilitate one or more suggested modes as described in the present application may apply to any environment, whether wired or wireless, and may be applied to any number of such devices connected via a communications network and interacting across the network. Therefore, no one mode should be limited to any single embodiment, but rather should be construed in breadth and scope in accordance with the appended claims.

What is claimed is:

1. A vehicle intrusion alert device (VIAD) configured to communicate with a mobile platform application (MPA) executing on a remote user device, comprising:
means for registering the VIAD with the MPA;
means for enabling the VIAD to receive instructions from the MPA which set the VIAD between armed and disarmed modes;
means for transmitting position location indicia of the VIAD while in the armed mode, the position location indicia being for use by the MPA to graphically plot VIAD position; and
means for detecting an intrusion event and generating an intrusion indication signal to the MPA.

2. The VIAD of claim 1, wherein the VIAD can only be disarmed by the MPA.

3. The VIAD of claim 1, further comprising a solar-powered battery source.

4. The VIAD of claim 1, wherein the means for transmitting position location indicia includes an integrated GPS receiver.

5. The VIAD of claim 1, further comprising means for receiving initialization settings based on user selections from the MPA.

6. The VIAD of claim 1, wherein the VIAD does not include alphanumeric keys.

7. The VIAD of claim 1, further comprising a baseband processor configured to link directly to the MPA over an internet link established by a data mobile network infrastructure.

8. The VIAD of claim 1, further comprising means for transmitting a battery status indication signal to the MPA.

9. The VIAD of claim 1, wherein the means for detecting an intrusion event includes an impact sensor.

10. In a user device, a method of generating an intrusion alert in response to information from a vehicle intrusion alert device (VIAD), comprising:
detecting a user selection to arm the VIAD;
generating a signal to cause the VIAD to enter into armed mode;
receiving position location indicia from the VIAD while in the armed mode;
graphically plotting position coordinates associated with the VIAD using the position location indicia; and
generating an intrusion alert in response to an intrusion indication signal being detected from the VIAD.

11. The method of claim 10, further comprising means for placing an emergency request call.

12. The method of claim 10, wherein the position location indicia is stored on a central server, the method further comprising requesting the position indicia from the central server.

13. The method of claim 10, wherein the position location indicia is stored in a local memory of the user device, the method further comprising retrieving the position indicia from the memory.

14. The method of claim 10, further comprising:
displaying a list of periods during which the VIAD was armed and was generating position location indicia;
determining a user selection of one of the periods; and
retrieving and graphically plotting position coordinates for the one period of which the user selection is determined.

15. The method of claim 10, further comprising receiving an indication signal of a battery charge status of the VIAD and displaying the battery status of the VIAD.

16. The method of claim 10, further comprising transmitting initialization settings to remotely initialize and program the VIAD.

17. The method of claim 10, wherein the VIAD does not include alphanumeric keys and can only be disarmed remotely.

18. A method of intrusion alert tracking and record management by a central server including a database comprised of records of position location indicia and intrusion indication signals for a plurality of vehicle intrusion alert devices (VIADs) registered to the central server and monitored by remote user devices configured to communicate with the VIADs over a wireless communication network, the method comprising:
receiving an authentication request by a remote user device to access a record of a corresponding VIAD;
retrieving the record of the corresponding VIAD and transmitting it to the authenticated remote user device;
further receiving a request from the authenticated remote user device to set the corresponding VIAD in armed mode;
processing the request and remotely generating an instruction to the corresponding VIAD to enter armed mode;
receiving new position location indicia and intrusion indication signals and updating the record for that VIAD;
transmitting the new position location indicia and intrusion indication signals in real time to the authenticated remote user device;
detecting when an intrusion indication signal is indicative of an actual intrusion;
generating a real time alert to the authenticated remote user device;
detecting a request from the authenticated remote user device to take a selected action in response to the real time alert; and
performing the selected action.

19. The method of claim 18, further comprising:
detecting a request from the authenticated remote user device to place the corresponding VIAD in disarmed mode; and
processing the request and remotely generating an instruction to the corresponding VIAD to enter the disarmed mode, wherein the corresponding VIAD may not be disarmed except by such generated instruction.

20. The method of claim 18, further comprising:
receiving a battery status indication signal from the corresponding VIAD; and
when the authenticated remote user device is in the armed mode, sending a battery status indication signal thereto.

21. An intrusion alert device configured to communicate with a mobile platform application (MPA) executing on a remote user device, comprising:
means for registering the intrusion alert device with the MPA;
means for enabling the intrusion alert device to receive instructions from the MPA which set the intrusion alert device between armed and disarmed modes;
means for transmitting position location indicia of the intrusion alert device while in the armed mode, the position location indicia being for use by the MPA to graphically plot a position of the intrusion alert device; and
means for detecting an intrusion event and generating an intrusion indication signal to the MPA.

22. In a user device, a method of generating an intrusion alert in response to information from an intrusion alert device, comprising:
detecting a user selection to arm the intrusion alert device;
generating a signal to cause the intrusion alert device to enter into armed mode;
receiving position location indicia from the intrusion alert device while in the armed mode;
graphically plotting position coordinates associated with the intrusion alert device using the position location indicia; and
generating an intrusion alert in response to an intrusion indication signal being detected from the intrusion alert device.

23. A method of intrusion alert tracking and record management by a central server including a database comprised of records of position location indicia and intrusion indication signals for a plurality of intrusion alert devices registered to the central server and monitored by remote user devices configured to communicate with the intrusion alert devices over a wireless communication network, the method comprising:
receiving an authentication request by a remote user device to access a record of a corresponding intrusion alert device;
retrieving the record of the corresponding intrusion alert devices and transmitting it to the authenticated remote user device;
further receiving a request from the authenticated remote user device to set the corresponding intrusion alert device in armed mode;
processing the request and remotely generating an instruction to the corresponding intrusion alert device to enter armed mode;
receiving new position location indicia and intrusion indication signals and updating the record for that intrusion alert device;
transmitting the new position location indicia and intrusion indication signals in real time to the authenticated remote user device;
detecting when an intrusion indication signal is indicative of an actual intrusion;
generating a real time alert to the authenticated remote user device;
detecting a request from the authenticated remote user device to take a selected action in response to the real time alert; and
performing the selected action.
